(19) United States
(12) Patent Application Publication
(10) Pub. No.: US 2016/0199248 A1
(43) Pub. Date: Jul. 14, 2016

(54) CONTROL SYSTEM FOR DEEP TOUCH PRESSURE SENSORY TREATMENT DEVICES, METHOD OF MANUFACTURE AND METHOD OF USE

(71) Applicant: The Sensory Chair Company, Inc., Overland Park, KS (US)

(72) Inventors: Stuart T. Jackson, Overland Park, KS (US); Gregory T. Russell, Overland Park, KS (US)

(21) Appl. No.: 15/080,050

(22) Filed: Mar. 24, 2016

Related U.S. Application Data
(63) Continuation-in-part of application No. 14/958,636, filed on Dec. 3, 2015.
Application No. 14/958,636 is a continuation-in-part of application No. 14/816,907, filed on Aug. 3, 2015.
(60) Provisional application No. 62/087,553, filed on Dec. 4, 2014.
(60) Provisional application No. 62/087,553, filed on Dec. 4, 2014.

(51) Int. Cl. A61H 9/00

(52) U.S. Cl. CPC A61H 9/0078; A61H 2201/1238; A61H 2201/5071

(57) ABSTRACT

A control system for controlling air pressure within a sensory treatment device, such as a sensory chair or lounger. The control system includes a power source, an air pump, a pressure sensor, a pressure relief valve, and a power switch. The control system is connected to inflatable air tubes located in the sensory treatment device and is activated to inflate the inflatable air tubes to a preset upper pressure limit. The control system is further configured to cycle the pressure within the air tubes between the upper pressure limit and a preset lower pressure limit, thereby creating deep touch pressure to an occupant within the sensory treatment device.

### CROSS-REFERENCE TO RELATED APPLICATIONS

This application is a continuation-in-part of and claims priority in U.S. patent application Ser. No. 14/958,636, filed Dec. 3, 2015, which claims priority in U.S. Provisional Patent Application No. 62/087,553, filed Dec. 4, 2014, and is also a continuation-in-part of and claims priority in U.S. patent application Ser. No. 14/816,907, filed Aug. 3, 2015, which claims priority in U.S. Provisional Patent Application No. 62/087,553, filed Dec. 4, 2014, all of which are incorporated herein by reference.

### BACKGROUND OF THE INVENTION

1. Field of the Invention

The present invention relates generally to a control system, enclosure, and method of use, and more specifically to a control system that provides controlled inflation to air tubes enclosed within sensory treatment devices that apply deep touch pressure to a person's body. Such devices can be used in, but are not limited to, the treatment of neurodevelopmental disorders such as sensory processing disorder, autism, and other neurological, neuropsychological and physical conditions.

2. Description of the Related Art

Deep touch pressure is a form of tactile sensory input, often provided by firm holding, firm stroking, hugging, swaddling, and squeezing. A non-invasive and easily applied therapeutic method, deep touch pressure generally provides a calming effect for the recipient. A growing body of literature shows that deep touch pressure is helpful for managing anxiety and reducing maladaptive behaviors in people with cognitive developmental disorders, sensory processing disorder, psychological disorders, and certain other neurological and physical conditions. Research also shows that deep touch pressure can improve the quality of life for people experiencing anxiety, pain and unrest

A sensory treatment device system known as the Sensory Lounger disclosed in U.S. patent application Ser. No. 14/816,907 (the “'907 application”) filed Aug. 3, 2015, owned by the Sensory Chair Company, Inc. of Overland Park Kans., and incorporated herein by reference, was developed to provide deep touch pressure to a person in a comfortable manner, adaptable to persons of varying shapes and sizes, in which the person lies down between two air tubes which are subsequently inflated to provide deep touch pressure. In the '907 application, the device was configured such that the occupant was able to lay down and shift into several positions such as supine position, prone position, lying on either side, squatting, crouching, sitting up and kneeling while receiving deep touch pressure.

A second sensory treatment device system known as the Sensory Upright Chair disclosed in U.S. patent application Ser. No. 14/958,636 (the “'636 application”) filed Dec. 3, 2015, owned by the Sensory Chair Company, Inc. of Overland Park Kans., and incorporated herein by reference, was developed to provide deep touch pressure to a person in a comfortable manner, adaptable to persons of varying shapes and sizes, in which the person sat upright between two air tubes which were subsequently inflated to provide deep touch pressure. The primary difference between the '907 application and the '636 application was the orientation of the occupant while receiving deep touch pressure. In the '636 application, the device was configured such that the occupant was sitting in an upright position while receiving deep touch pressure.

For both the Sensory Lounger (the '907 application) and the Sensory Upright Chair (the '636 application), the need for controlled inflation of air tubes was briefly described. The inflated air tubes would gradually come into contact with the occupant and apply deep touch pressure in both of these devices.

Controlled inflation of air compartments that come into contact with a person has previously been described, most notably in chair type massage machines such as that presented in U.S. Patent Application Publication No. US 2010/0198121 published Aug. 5, 2010. In these types of devices, air cells at various parts of the body are inflated and deflated in sequences designed to either sense the position of a body part prior to applying a ball or other vibrating or undulating type massage treatment, or to shift the position of the body so that a certain type of massage treatment can be applied to a certain preferred area of the body, or to hold the body still and in place while a certain massage treatment is applied. Unlike the present invention, the objective of controlled air cell inflation in chair type massage machines is not to have these cells apply deep touch pressure to the user's body.

Another application employing controlled inflation of air-filled or fluid-filled compartments that come into contact with a person can be found in compression therapy devices such as that presented in U.S. Patent Application Publication No. US 2013/0231596 published Sep. 5, 2013. In these types of devices, sequential compression therapy is applied via an inflatable sleeve with one or more compartments wrapped around a certain part of the body (such as the calf or thigh) to prevent deep venous thrombosis (DVT). Such devices use controlled inflation of cells to provide a level of deep pressure in a series of pulses. Unlike the present invention, the deep pressure provided by such devices is purely intended to provide DVT prophylaxis, and is not intended for managing anxiety and reducing maladaptive behaviors in people with neurological disorders.

An extremely common application of controlled inflation of air compartments that come into contact with a person is a sphygmomanometer for measuring blood pressure. While manually inflated embodiments of this device are still in widespread use, electronic sphygmomanometers such as that described in U.S. Pat. No. 4,635,645 published Jan. 13, 1987, are commonplace. Unlike the present invention, the deep pressure provided by sphygmomanometers is purely intended to measure blood pressure, and is not intended for managing anxiety and reducing maladaptive behaviors in people with neurological disorders.

Heretofore there has not been available a method of providing electronically controlled inflation of air tubes that delivers deep touch pressure sensory treatment to a user with the advantages and features of the present invention.

### BRIEF SUMMARY OF THE INVENTION

The present invention provides a control system for deep touch pressure sensory treatment devices, its method of use and its method of manufacture. The system generally includes an enclosure, power supply, diaphragm air pump, pressure sensor, pressure release valve, control relay, terminal strip, power inlet module, on/off switch, wiring, piping and hardware. The system is connected to air tubes in the deep touch pressure treatment device.

In a preferred embodiment, the components of the system are contained within the enclosure attached to the frame of the sensory treatment device. The input is alternating current, the output is pressurized air. Three external controllers for the system, the on/off switch, the pressure sensor and the pressure release valve, are visible and accessible to an operator from the outside of the treatment device. When the system is switched on and the pressure release valve is in the closed position, the diaphragm pump will switch on and the system will start to inflate the air tubes in the treatment device. The air tubes will continue to inflate until the pressure in the system reaches a certain upper pre-set limit in the pressure sensor, at which point the diaphragm pump will switch off. Routine pressure reduction in the system occurs either by the occupant of the treatment device shifting position and/or by slow leakage which is designed into the system. The pressure reduction continues until a lower pre-set limit within the pressure sensor is reached, at which point, the diaphragm pump switches back on, and the air tubes inflate until the system once again reaches the upper pre-set pressure limit and the diaphragm pump switches back off. The pre-set pressure range (the difference between the upper and lower pre-set limits) is usually set to around 0.1 psi, but can be adjusted according to an occupant's preferences. The air tubes in the treatment device can be quickly deflated by switching the release valve to the open position.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention in a fully assembled state.

FIG. 2 is a three-dimensional isometric exploded view thereof.

FIG. 3 is another three-dimensional isometric exploded view thereof.

FIG. 4 is an isometric exploded view of a preferred embodiment of the present invention showing how it attaches to the air tubes and the frame of a deep touch pressure sensory treatment device.

FIG. 5 is an isometric view thereof in a fully assembled state fully attached to a deep touch pressure sensory treatment device thereof in its final state which includes a fabric cover.

FIG. 6 is a pneumatic schematic diagram of a preferred embodiment of the present invention.

FIG. 7 is an electrical schematic diagram of a preferred embodiment of the present invention.

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Control System for Sensory Treatment Devices 1

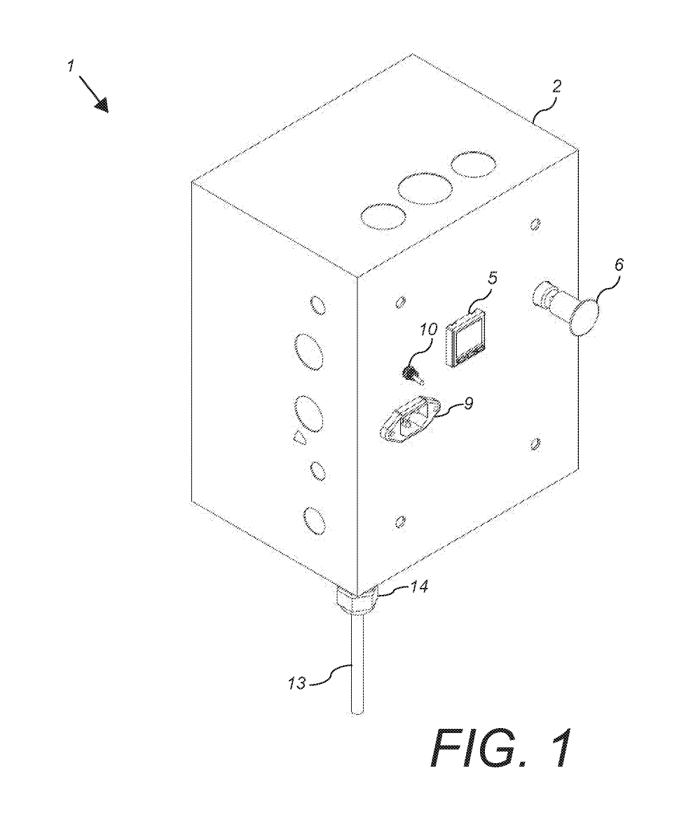

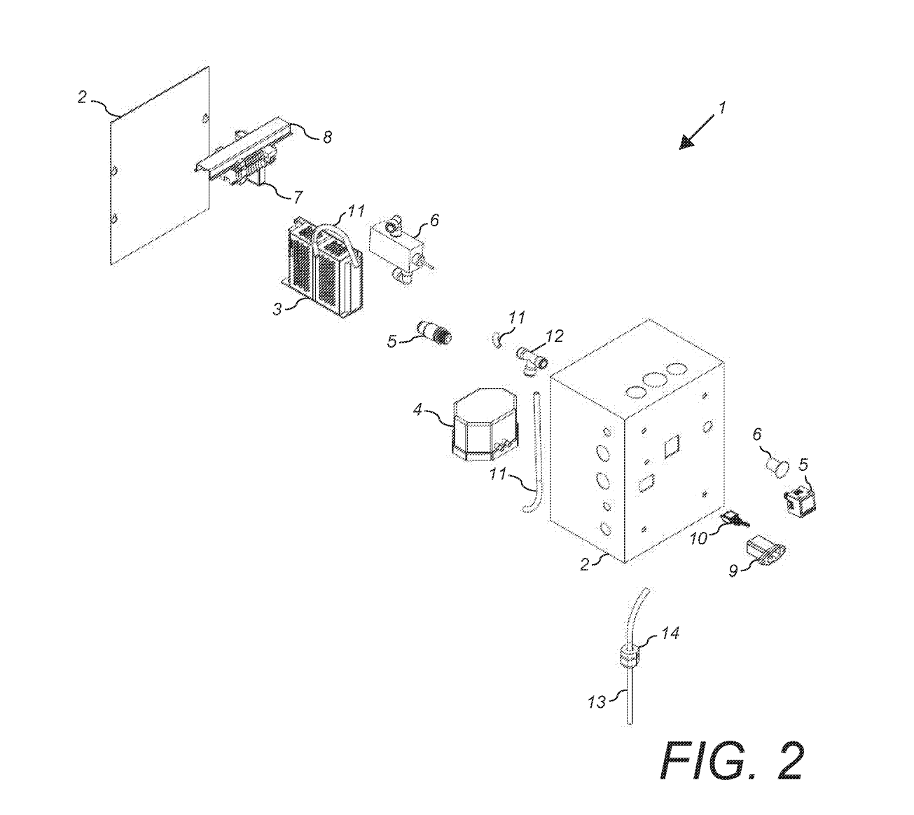

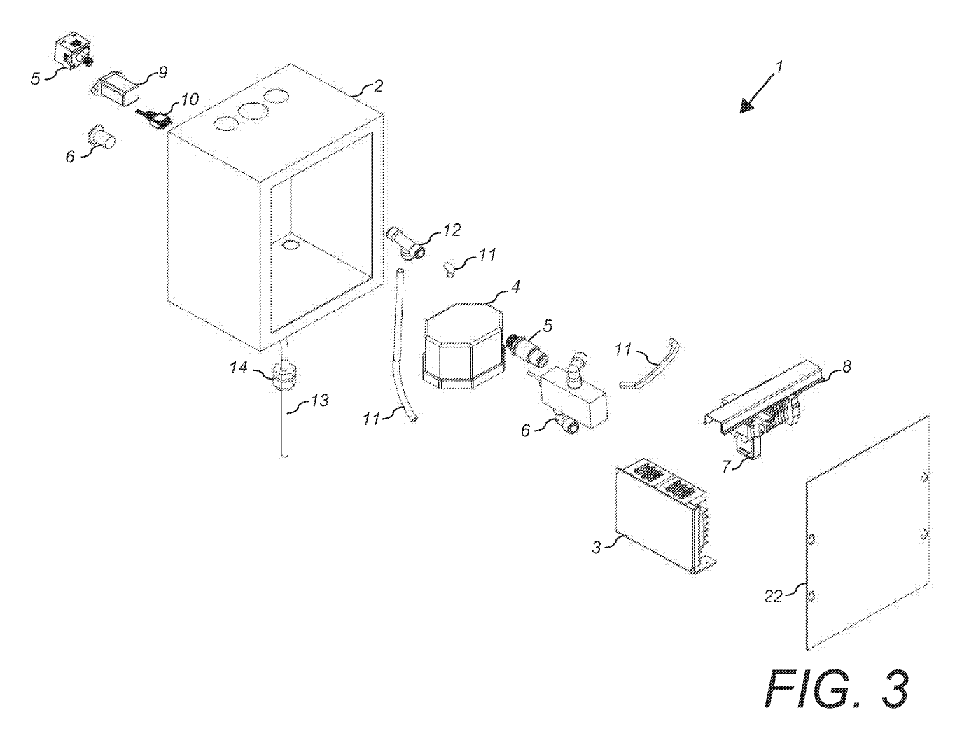

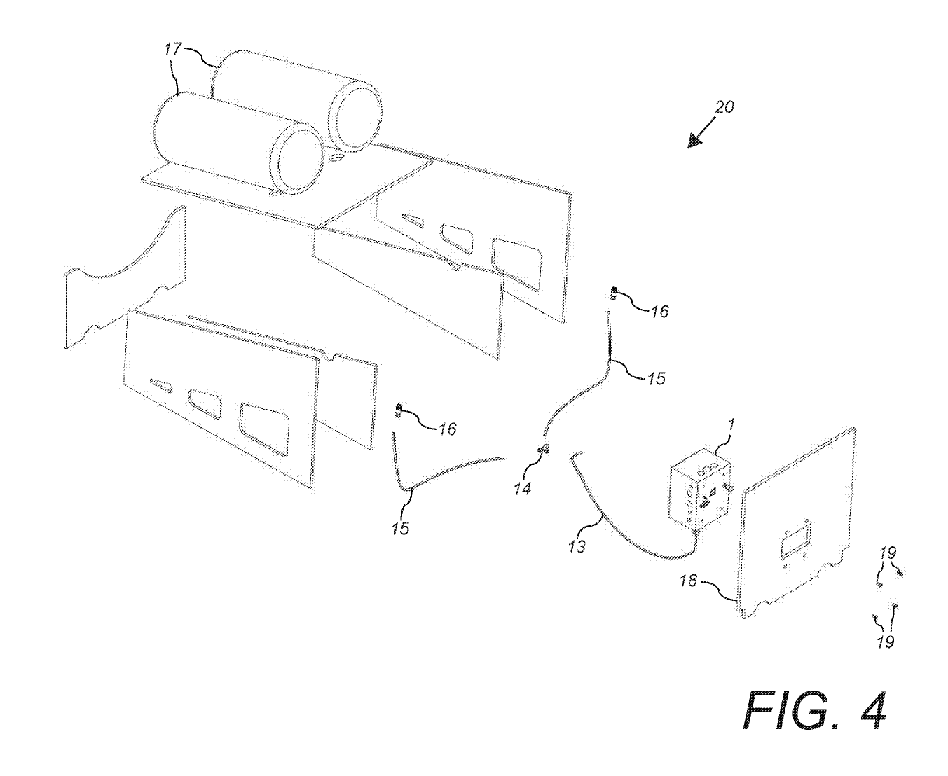

As shown in FIGS. 1-5, the present invention is a Control System 1 for Sensory Treatment Devices 20 (e.g. sensory furniture taught by U.S. patent application Ser. Nos. 14/816,907 and 14/958,636, previously incorporated herein by reference), the control system 1 which generally includes an enclosure 2 with a lid 22, a power supply 3, a diaphragm air pump 4, a pressure sensor 5, a pressure release valve 6, a pressure sensor relay 7, a terminal strip 8, a power inlet module 9, an on/off switch 10, internal piping 11, a T-valve 12, an outlet pipe 13 and a strain relief bushing 14.

The outlet pipe 13 is connected to the air tubes 17 of the sensory treatment device 20 via a T-valve 12, air hoses 15 and connectors 16.

The enclosure 2 is connected to a panel 18 in the sensory treatment device 20 via retaining bolts 19. An aperture in the panel 18 is located such that the three external controllers for the system, the on/off switch 10, the pressure sensor 5 and the pressure release valve 6, are visible and accessible to an operator from the outside of the sensory treatment device 20.

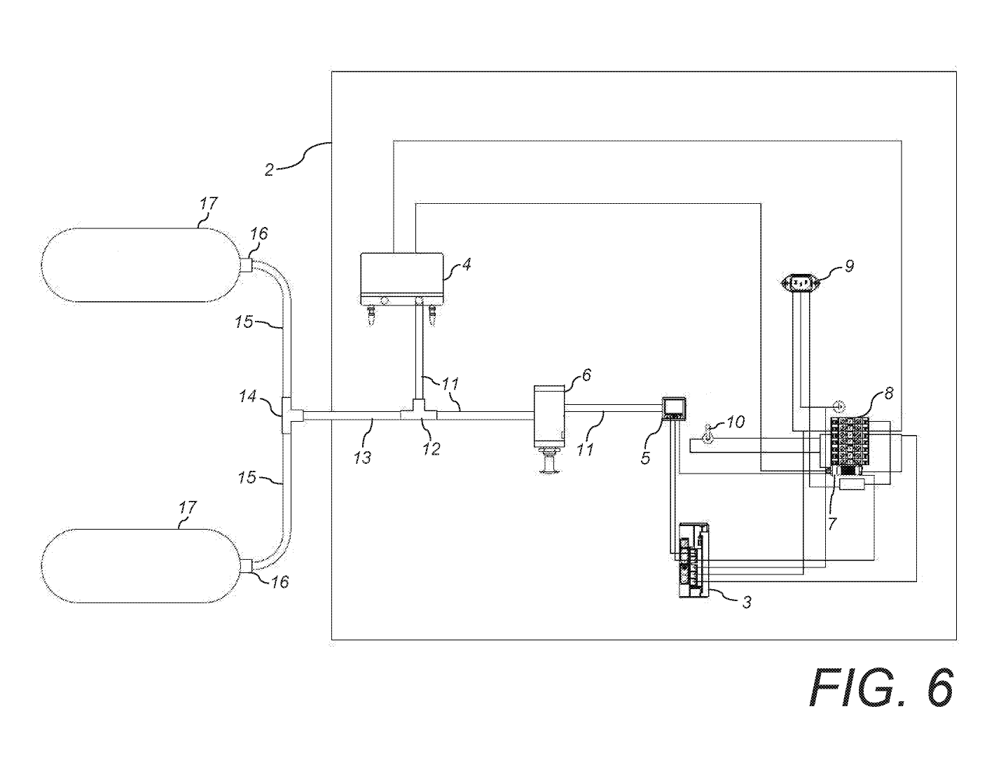

A pneumatic schematic diagram of the control system is shown in FIG. 6. The air inlet on the diaphragm pump 4 is open to the enclosure 2. The outlet on the diaphragm pump is connected by internal piping 11 to an interior T-valve 12 which is connected outwardly on one side via the outlet pipe 13 to an exterior T-valve 14, which is connected to the sensory treatment device air tubes 17 via air hoses 15 and connectors 16. The interior T-valve is also connected inwardly via internal piping 11 to the pressure release valve 6 and the pressure sensor 5. When the diaphragm pump is switched on and the pressure release valve is closed, the air pressure within the system increases until either a) the upper pre-set pressure limit in the pressure sensor is reached, at which point the diaphragm pump will switch off, or b) the pressure release valve is opened and the pressurized air is released into the enclosure.

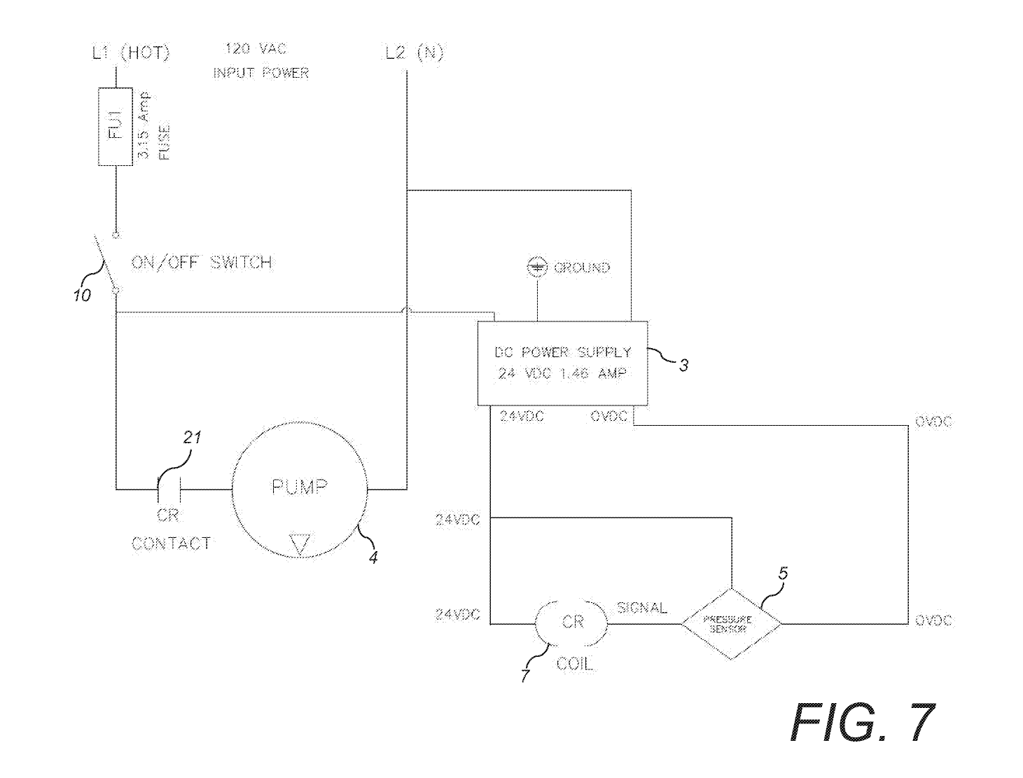

An electrical schematic diagram of the control system is shown in FIG. 7. When connected to an AC electrical source and switched on, if the upper pre-set pressure limit in the pressure sensor 5 has not yet been reached, the control relay contact 21 is closed and the diaphragm pump 4 switches on. When the upper pre-set pressure limit is reached, the control relay contact opens and the diaphragm pump switches off. When the lower pre-set pressure limit is reached, the control relay contact closes and the diaphragm pump switches on again. This cycle continues until the control system is switched off.

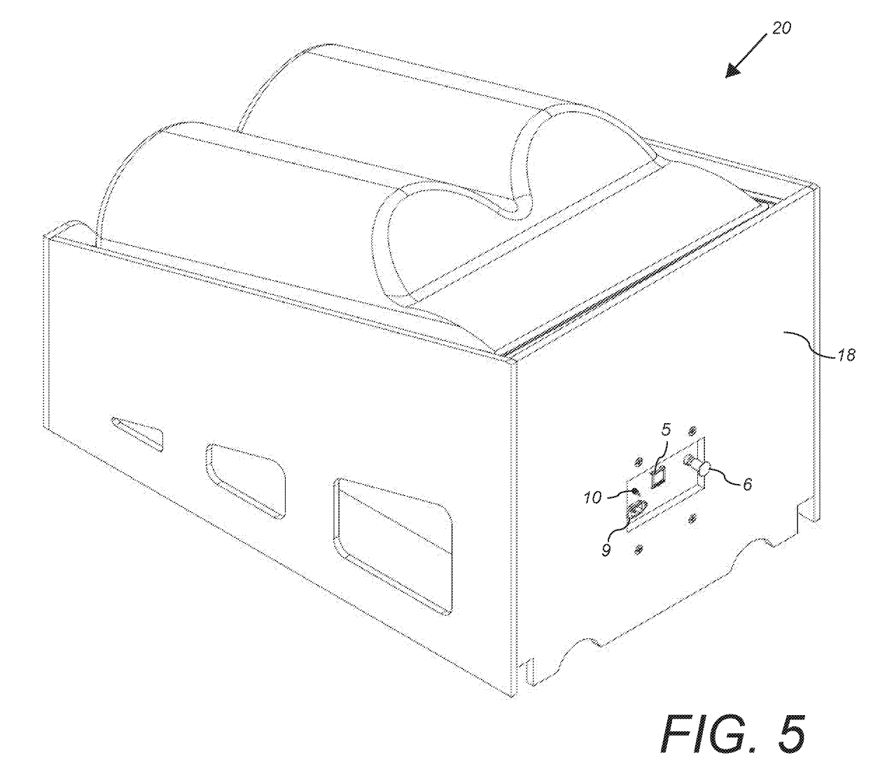

In a preferred embodiment, the components of the system are contained within the enclosure 2, usually attached to the frame of a sensory treatment device 20 via retaining bolts 19. The input of the system is alternating current via the power inlet module 9, and the output is pressurized air, which connects externally via the outlet pipe 13 to air tubes 17 in the device and provides deep touch pressure to an occupant of the device. Three external controllers for the system, the on/off switch 10, the pressure sensor 5 and the pressure release valve 6, are visible and accessible to an operator from the outside of the treatment device. In FIG. 5 it can be seen that these controls are located rearwardly relative to the sensory treatment device, although other embodiments could have them located forwardly, located in any position attached to the frame, or located within a remote device. When the system is switched on and the pressure release valve is in the closed position, the diaphragm pump 4 will switch on and the system will start to inflate the air tubes in the treatment device. The air tubes will continue to inflate until the pressure in the system reaches a certain upper pre-set limit in the pressure sensor, at which point the diaphragm pump will switch off. Pressure reduction in the system occurs either by the occupant of the treatment device shifting position and/or by slow leakage which is designed into the system. The pressure reduction continues until the lower pre-set limit within the pressure sensor is reached, at which point, the diaphragm pump switches back on, and the air tubes inflate until the system once again reaches the upper pre-set pressure limit and the diaphragm pump switches back off. The pre-set pressure range (the difference between the upper and lower pre-set limits) is usually set to around 0.1 psi, but can be adjusted according to an occupant's preferences. It should be noted that an alternative embodiment of the control system provides for a check valve to be located in series with the outlet pipe, which would eliminate the slow leakage in the system. However, the gentle intermittent cycling of air pressure within the control system between an upper and lower pre-set limit is a design feature of the sensory treatment device which has been found to be beneficial. The air tubes in the treatment device can be quickly deflated by switching the release valve to the open position.

The level of deep touch pressure provided by the system is maintained through the pressure sensor between the pre-set pressure range, but can be quickly released by opening the pressure release valve. Different levels of deep touch pressure can be achieved by adjusting the pre-set upper and lower pressure limits on the pressure sensor, or by making coarse pressure adjustments by opening and closing the pressure release valve.

An alternative embodiment remote version of the external controls may be provided by having the on/off switch, pressure sensor controls and release valve controls via a remote control unit, either wired to the control box or operated wirelessly.

An alternative embodiment constant pressure version of the control system provides for a check valve to be located in series with the outlet pipe, which would eliminate the slow leakage that is designed into the system.

Alternatively, a printed circuit board (PCB) could include components which replace the terminal strip 8, control relay 21, and the pressure sensor 5 inputs and outputs. The PCB could perform additional programmed functions, such as reporting the current pressure of the inflated device via a graphical interface display.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A control system for a sensory treatment device, the control system comprising:
an enclosure;
a power supply;
an air pump;
a pressure release valve;
a pressure sensor;
a power inlet module;
internal piping;
a first T-valve;
an outlet pipe;
an on/off switch;
said outlet pipe being connected externally to a pair of inflatable air tubes within the sensory treatment device via a second T-valve, a plurality of air hoses and a plurality of connectors; and
a controller assembly configured to inflate, deflate, and regulate air pressure within said pair of inflatable air tubes.

2. The system of claim 1, wherein said controller assembly comprises a pressure sensor control relay, and a terminal strip.

3. The system of claim 1, wherein said controller assembly comprises a printed circuit board (PCB), wherein:
said PCB is configured to detect the pressure within said inflatable air tubes; and
said PCB is further configured to perform as a control relay between external controls and said air pump, said pressure release valve, and said on/off switch.

4. The system of claim 1, further comprising: said enclosure is connected to a panel in said sensory treatment device via at least one retaining bolt.

5. The system of claim 1, further comprising:
a first external control configured to operate the on/off switch;
a second external control configured to operate the pressure sensor;
a third external control configured to operate the pressure release valve; and
wherein said first external control, second external control, and third external control are visible and accessible from an exterior of said sensory treatment device.

6. The system of claim 5, wherein said first, second, and third external controls are configured to operate the control system thereby causing said air tubes to perform an action selected from the list comprising: inflate; and deflate.

7. The system of claim 5, first, second, and third external controls are configured to cycle air pressure in the sensory treatment device within a pre-determined upper pressure range and a pre-determined lower pressure range.

8. The system of claim 1, wherein: said pressure release valve is configured to quickly reduce the air pressure in the sensory treatment device.

9. A control system for a sensory treatment device, the control system comprising:
an enclosure configured to house a power supply, an air pump; a pressure sensor, a pressure release valve, a pressure sensor control relay, a terminal strip, a power inlet module, an on/off switch, internal piping, and a first T-valve, the combination of which comprises a controller box assembly;
a sensory treatment device including a frame having a removable panel, a pair of inflatable air tubes, and a cover configured to cover said inflatable air tubes;
said controller box assembly placed within said frame and connected to said inflatable air tubes;
said controller box assembly configured to be switched between an first, active state, a second, deflate state, and a third inactive state;
wherein said controller box assembly in said first, active state is configured to cause said air tubes to inflate;
wherein said controller box assembly in said second, deflate state is configured to cause said air tubes to deflate; and
wherein said controller box assembly in said third, inactive state is configured to power down said controller box assembly.

10. A method of operating the control system for sensory treatment devices, the method comprising the steps:
connecting an outlet pipe of the control system to a pair of external inflatable air tubes located within the sensory treatment device;
powering on said control system with a power switch connected to a power source;
switching the control system to an active state by activating a pressure release valve, thereby setting said pressure release valve to a first, closed position;
inflating the said external inflatable air tubes with a diaphragm pump thereby adding pressure to said external inflatable air tubes;
detecting an air pressure status within the external inflatable air tubes with a pressure sensor and regulating said pressure within a preconfigured upper pressure limit and a lower pressure limit; and
cycling pressure within the external inflatable air tubes between said preconfigured upper pressure limit and said preconfigured lower pressure limit.

11. The method of claim 10, further comprising the steps:
opening said pressure release valve; and
deflating said external inflatable air tubes.

12. The method of claim 10, further comprising the steps:
switching the control system to an inactive state via said power switch; and
stopping the cycling of pressure within the system.

13. The method of claim 10, further comprising the step of controlling the air pressure status within the external inflatable air tubes by opening and closing the pressure release valve.

14. The method of claim 10, wherein a check valve is inserted in series with the control system's outlet pipe, said check valve configured to reduce air pressure leakage and thereby to eliminate air pressure cycling between said preconfigured upper pressure limit and said preconfigured lower pressure limit.
